(19) United States
(12) Patent Application Publication
(10) Pub. No.: US 2002/0162920 A1
(43) Pub. Date: Nov. 7, 2002

(54) Mouse support assembly

(76) Inventor: Glenn R. Cruzet, Pickering (CA)

Correspondence Address: William P. Ramey, III, Suite 1800, 1900 West Loop South, Houston, TX, 77027, US

(21) Appl. No.: 09/848,460

(22) Filed: May 3, 2001

(51) Int. Cl. B43L 15/00

(52) U.S. Cl. 248/118.1

(57) ABSTRACT

A new and improved support platform is provided that provides for ergonomic comfort. The support platform having a wrist support element and an opposite mechanical stop element that rotate about the platform to provide for enhanced operation of a pointer device, such as a mouse, trackball or such. The support platform capable of connection to prior art computer workstations for enhancing the overall ergonomics of the computer workstation.

### TECHNICAL FIELD

The present invention generally relates to an improved support assembly for ergonomically supporting a computer pointer device, such as a mouse. The support assembly providing a surface on which to maneuver a pointing device such as mouse, trackball or such. The support assembly is pivotally coupled to a computer workstation such as a desk, keyboard or computer keyboard support to rotate around a fixed pivot point. The support having an adjustable wrist support element and mechanical stop, for example, a mouse guard, that may be moved through a plurality of positions for optimal ergonomic comfort and control.

### BACKGROUND ART

Computers have gained increasing importance in today's society. As such, more and more people are working in front of a computer to perform their daily tasks.

Computers have developed from crude instrumentalities where all data was entered from a keyboard to user friendly devices that have incorporated pointer devices. These pointer devices, including the mouse, the trackball and others, have made the entering of data and navigation of a computer far easier. As such, almost all computer users find themselves using some form of a pointer device to assist in their work on computers.

Primarily, computer work stations of today have a pointing device such as a mouse or trackball that has a housing separate from the computer keyboard and is connected to the computer by wires or a transmitted signal such as an infra red signal. It is widely known and understood in the art that reference to the term mouse is synonymous with all related pointer devices. Accordingly, the remainder of this disclosure may refer only to a mouse when speaking of all pointer devices.

A mouse operates by producing a two dimensional displacement signal that is used to control the position of a screen cursor as needed. Common examples of the use of a mouse are to highlight, move (“drag”) or select (“click on”) certain icons, text or the whatever else the operator may desire. Other uses for a mouse include drawing and navigating the World-Wide Web. Moreover, the majority of the computer applications of today require the use of a mouse.

The typical construction of a mouse is a hand size or slightly larger or smaller device that may either be moved over a surface or actuated. For the embodiments of a mouse that require movement, it is common to provide a mouse pad. As well, a typical mouse has one or more buttons for operation and application of differing features. However, a universal truth is that the mouse must be manually accessible to the user of the work station and be situated where the mouse may be used with relative ease.

A common problem associated with using a computer and a mouse on a desk or table is that of finding adequate space for the computer and accessories. Moreover, the space usually found for the mouse is not adequate, thus resulting in an operator frequently maintaining his or her arm in a partially raised position for extended periods of time. This raised position of the arm causes arm fatigue and can cause injuries.

Some prior art methods and apparatuses have developed so that the operator can extend a sliding side panel from a desk or table or mount a side panel on a desk and operate the mouse from these positions. One such example is found in U.S. Pat. No. 5,876,002 to White et al. The arm and support of that patent provide a support plate which may be removably mounted on a desk top, table, or on a drawer extended from the desk or table. A purpose of the invention is to extend the surface of the desk top or table and support the mouse pad and mouse to a more accessible location for the mouse user, and provide a support upon which the user's forearm may rest while operating the mouse. However, inventions of this type provide only an extensible platform on which to operate a mouse and do not necessarily alleviate any of the discomfort associated with using a mouse because the positioning of the hand on the mouse is not ergonomically sound.

Other solutions in the prior art have attempted to reduce the discomfort associated with using a mouse by decreasing the distance a user is required to move their hand before being able to actuate a mouse. One such example is found in U.S. Pat. No. 5,413,294 to Greenquist. In that patent a cover is disclosed that the operator may place over the unused portion of an extended keyboard, thereby decreasing the distance a user has to move in order to actuate a mouse. However, this invention decreases the utility of a keyboard and severely limits the manner of data entry that an operator may employ. Additionally, this prior art apparatus does nothing to increase the comfort during the use of a mouse because the position of the users hand is not ergonomically sound.

With the onset of increased computer use has come an increased awareness of injuries that can develop from the numerous repetitive motions associated with standard computer usage. The science relating to this awareness is generally referred to as ergonomics or office ergonomics and relates to the correct positioning of a person in the office to minimize injuries from daily tasks.

In response to ergonomics, office furniture and office product manufacturers have developed and offered a wide variety of products that are marketed as ergonomic. Unfortunately, most of these items fail to be truly ergonomic or have any indicia of ergonomic soundness. Even worse, many of the products worsen the situation by encouraging operators to assume unhealthy postures. Examples of such would include adjustable-height tables and desks, and adjustable keyboard and computer mouse supports that do not adjust to the optimal conditions for ergonomic comfort. As a result, many consumers are encouraged to purchase unsound equipment that advertises ergonomic effects while producing little return.

Positive ergonomic results have been found from such adjustments to the workstation as tilting the keyboard or mouse support, putting swivels on the platforms or simply repositioning the arrangement of the computer workstation. For example, it has been found to be advantageous to configure the computer workstation so that the operator should be able to reach a mouse without even looking at either of the mouse or the keyboard. However, adjustments in the keyboard position and computer work station configuration produce problems with respect to where the mouse is located and how it is used.

It is commonly understood that a mouse pad is preferably fixed substantially horizontally at or slightly above the elevation of the keyboard. A correct positioning for a mouse pad is located adjacent to the keyboard, such as along an arc around the user's elbow having a radius equal to the length of the forearm. This permits the user to switch quickly between the keyboard and the mouse. Nevertheless, users differ in size, left or right-handedness and other various preferences. A right handed user may wish temporarily to operate a mouse with the left hand, for example when operating a numeric keypad with the right hand. As a result, some adjustability is advantageous. Accordingly, the art field is in search of a mouse support pad that may be adjusted through a plurality of positions to accommodate each individual user while providing ergonomic comfort and relief through sound ergonomic design.

One prior art attempted solution is found in U.S. Pat. No. 5,927,662 to West et al. The patent discloses a a keyboard support arrangement which includes both a main support pad for a keyboard, and an auxiliary support pad for a mouse. The auxiliary support pad is removably and multiply positionable on and relative to the main support pad to provide increased convenience and flexibility of use with respect to the mouse support pad. The auxiliary pad may be separable from the main pad, and a releasable and multi-positional connecting structure is provided for permitting the auxiliary pad to be mounted directly on the main pad adjacent either side edge thereof. The patent further discloses a wrist support element connected to the auxiliary support pad. However, the patent does not discloses an ergonomically adjustable computer pointer support device that may be adjusted through a plurality of positions. Further, the patent does not provide a great amount of flexibility of positioning of the auxiliary pad in relation to a user. Therefore, a user of a device constructed according to this patent is forced to adjust his or her position to properly utilize the auxiliary pad. Accordingly, the art field is in search of a mouse support pad that allows flexibility of positioning through a plurality of positions that may be connected to prior art computer workstations while providing sound ergonomic design.

As used herein, the term computer workstation means, refers and includes a computer workstation, computer keyboard support, keyboard support and like structures common in the art for providing support for a keyboard, mouse and/or other accessories.

### SUMMARY

An improved mouse support platform is provided that provides ergonomic comfort for a user while providing for maximum utility of a pointer device. The device generally includes a partially circular portion and a rotatable wrist support element and mechanical stop.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is an illustration of an embodiment of the present invention from a top perspective.

FIG. 2 is an illustration of the embodiment of FIG. 1 from a bottom perspective.

FIG. 3 is an illustration of the embodiment of FIG. 1 from a side perspective.

### GENERAL DESCRIPTION AND PREFERRED MODE FOR CARRYING OUT THE INVENTION

Various embodiments of the invention will be described in the following paragraphs. Different reference numerals have been used in each illustration in an effort to more clearly define the invention. However, the different reference numerals when applied to common parts in the different illustrations do not indicate that the parts are not the same and not describing a common invention. The different reference numerals represent the scope of the invention and are not meant to limit the embodiments of the invention.

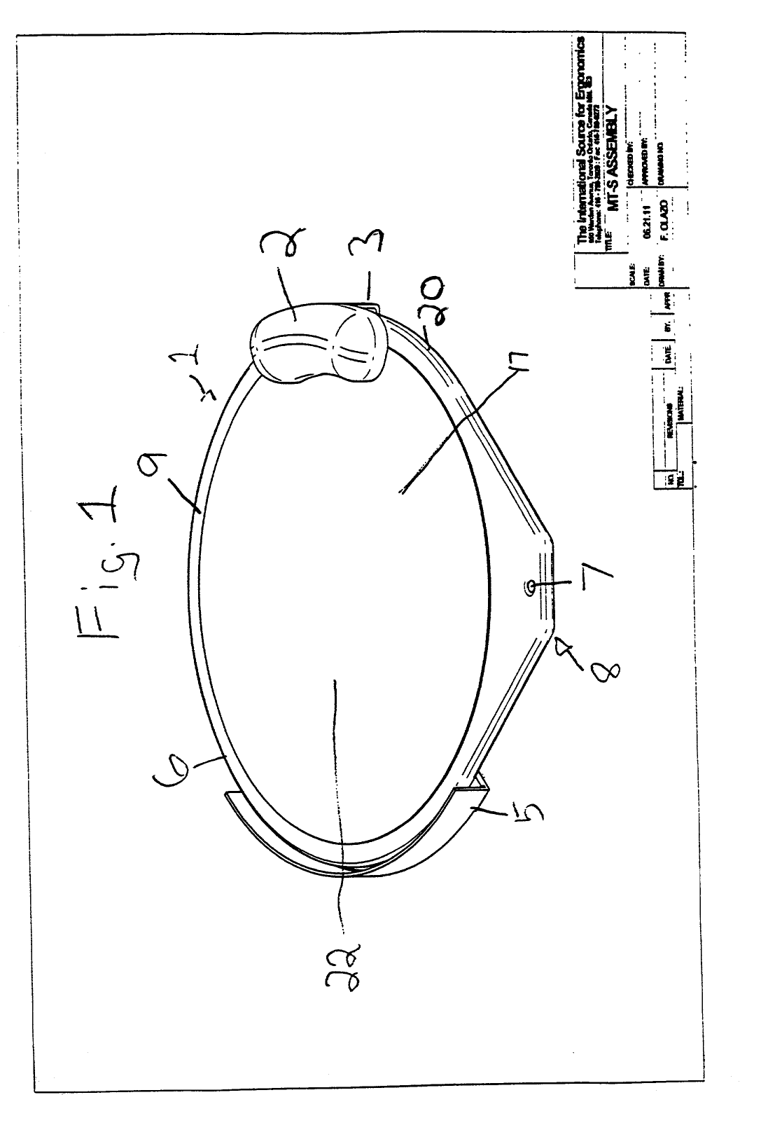

Now referring to FIG. 1, an illustration of an embodiment of the present invention from a top perspective, the general shape of an embodiment of the present invention may be seen. In this embodiment, mouse platform 1 is generally a circular shape with a non-circular portion 8. A shape of base plate 6 may be described as a circular plate with a generally square portion 8 extending from about 1 to 180 degrees of the circle. In an embodiment, the square portion extends from about 90 degrees of the circle. The portion 8 extends away from base plate 6 for a connection 7. However, the scope of the present invention envisions any other shapes and/or configurations of a support such as purely circular, eliptical, quadrangular, triangular or others.

Connection 7 may be utilized to connect the mouse platform 1 to a computer workstation, extensible arm or other devices or structures common in the art. In this embodiment, connection 7 is a swivel or universal connector that may be attached to other devices to provide for a wide range of movement of the support for the ideal ergonomic positioning. In another embodiment, connection 7 is attached to an arm that may be connected from a computer workstation or other support device such as a keyboard support or computer keyboard support. The arm would allow the support to be selectively positioned about the computer workstation. An embodiment of an arm allows complete rotation of the mouse platform 1 from one side to the other of the computer workstation or keyboard platform or computer keyboard platform.

Mouse platform 1 is generally constructed of a base plate 6. In various embodiments, base plate 6 generally extends in a planar orientation. Base plate 6 may be constructed of any material common in that will produce a durable material capable of supporting the weight of an arm of a user or operator. In other embodiments, base plate 6 is constructed of a plastic or other resin or laminate material. However, other embodiments of the invention utilize wood or metals such as aluminum, steel, tin, or copper. Mouse pad 4 should be constructed of materials that are resilient and pliable such as plastics, foams, or sponges. However, other embodiments utilize a rigid plate of material such as a plastic, metal, wood or other resin.

The upper surface 9 of base plate 6 typically has a mouse pad 4 lying thereon. Mouse pad 4 generally provides a surface over which to actuate a pointer device such as a mouse or trackball. As such, the upper surface 9 of mouse pad 4 should provide a sufficiently high coefficient of friction to actuate a mouse.

In other embodiments, base plate 6 is used without mouse pad 4. In such embodiments, the upper surface 9 of base plate 4 should be of a sufficiently high coefficient of friction to actuate a mouse.

Mouse pad 4 may be fixedly attached to base plate 6 with a glue or an adhesive. However, in other embodiments, mouse pad 4 is rotatably connected to base plate 6 by a swivel or bearing (not shown). In an embodiment, mouse pad 4 is rotatably connected to wrist support arm 3 across base plate 6 by any manner common in the art such as a swivel, bearing or screw/bolt such that as the wrist support arm rotates, mouse pad 4 rotates. In another embodiment, mouse pad 4 is molded such that it extends over and is at least partially retained by a portion of base plate 6, whereby mouse pad 4 may rotate.

In other embodiments, wrist support arm 3 extends across a diameter of the circular portion 22 of support platform 1 having a proximal and a distal end. In another embodiment, wrist support arm 3 extends along a diameter of the lower surface (not shown) of support platform 1. About an end, referred to as the proximal end, is a wrist support 2. Wrist support arm 3 generally extends from the lower surface of support platform 1 in a C configuration about a portion of a side surface 20 of support platform 1 to provide a surface on which to attach wrist support 2. Wrist support 2 is preferably removably attached to wrist support arm 3 so that a user may select the wrist support 2 that most accommodates his or her wrist to provide the greatest amount of ergonomic comfort. As such, embodiments of the present invention utilize both a fixed mounting, such as an adhesive or bolts, and a removable mounting, such as screws, velcro and the like, for mounting wrist support 2 to wrist support arm 3.

Wrist support 2 is an ergonomically sound support that provides for the positioning of a wrist of a user over the support platform while providing both comfort and support during use.

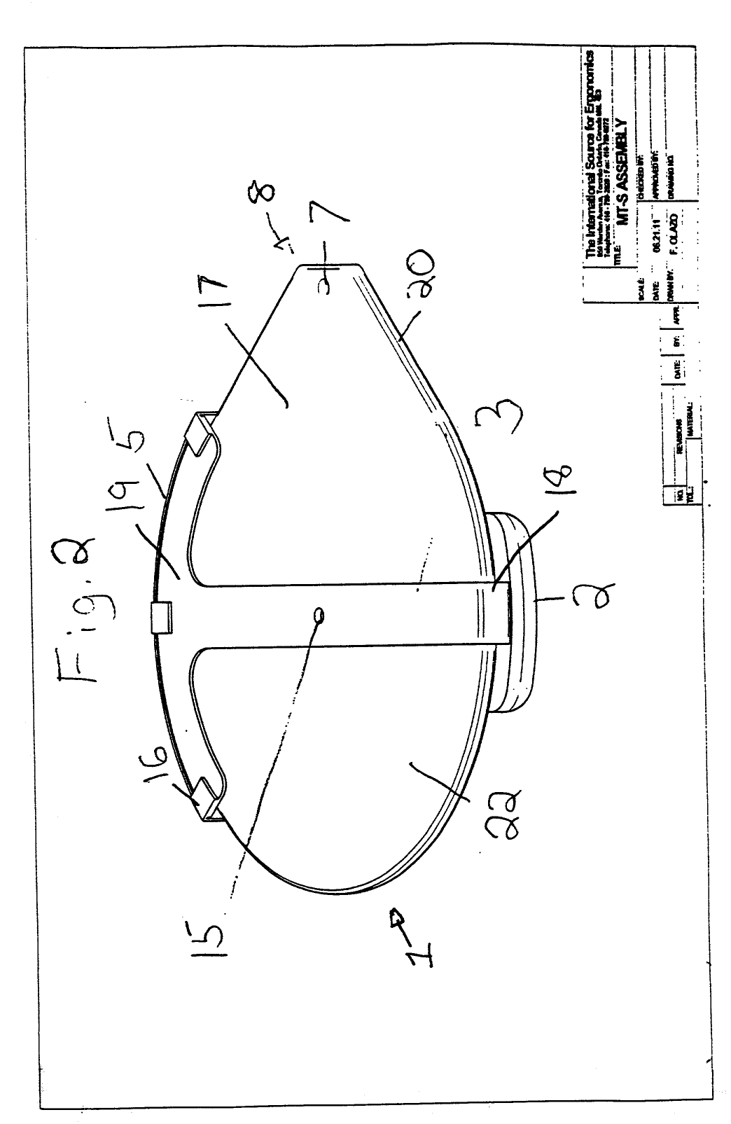

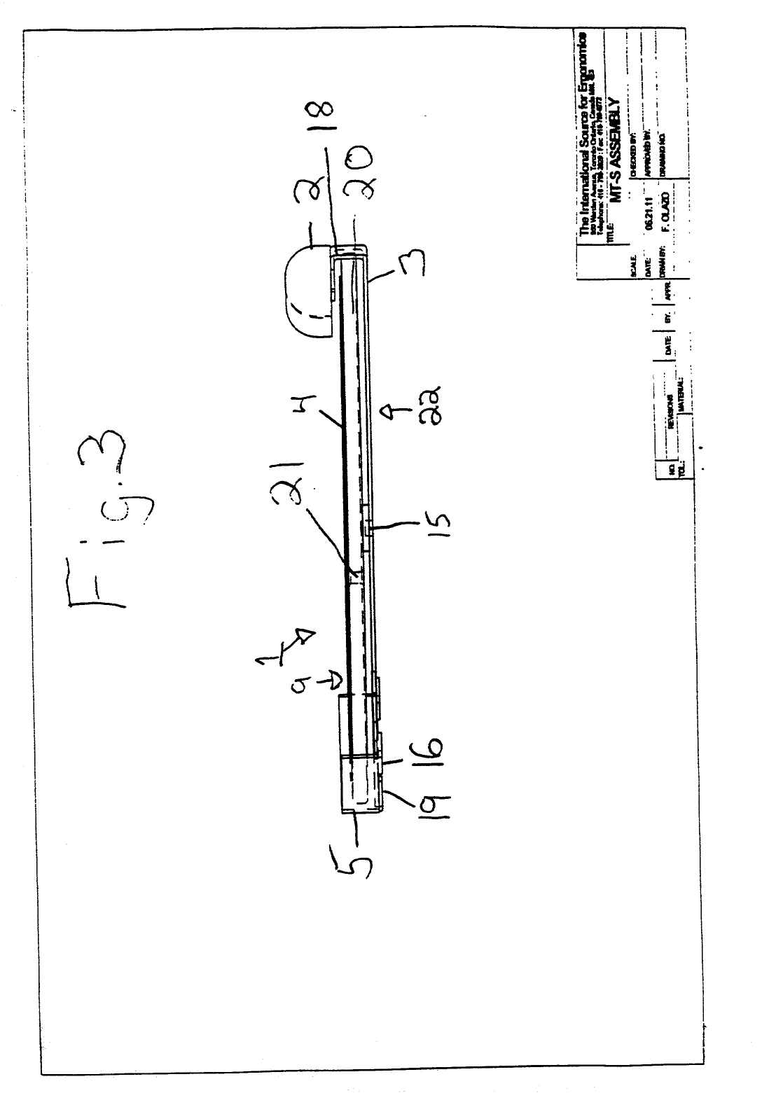

The other end of wrist support arm 3, referred to as the distal end, is connected to a mechanical stop 5, a raised portion, that extends from wrist support arm 3 along side surface 20 above a plane of upper surface 9 to provide a limit or mechanical stop for the movement of a pointer device along upper surface 9. In an embodiment, mechanical stop 5 has a width of about 1.5 to 5.0 times the width of a pointer device. The connection of mechanical stop 5 to wrist support arm 3 will be more fully discussed in FIG. 2 and FIG. 3.

Now referring to FIG. 2, an illustration of the embodiment of FIG. 1 from a bottom perspective, the connection of wrist support arm 3 may be observed. Wrist support arm 3 is generally defined as a rigid bar that extends across a diameter of a circular portion 22 of support platform 1.and may be of any material common in the art that can provide a degree of rigidity such as a plastic, metal, wood or other resin.

Wrist support arm 3 is rotatably connected with brad 15 to support platform 1. The connection of wrist support arm 3 may be by any manner common in the art such as a brad, earing or swivel that allows rotation about support platform 1. In another embodiment, brad 15 extends across support platform 1 and rotatably connects to the mouse pad (not shown).

Rotation of wrist support arm 3 allows for an ergonomic positioning of the wrist of a user because the user may rotate the wrist support while maintaining his or her hand in a correct ergonomic position dependent upon a worksurface orientation and application, such as curved, diagonal or corner.

Proximal end 18 of wrist support arm 3 is preferably bent into a C configuration extending from lower surface 17, along side surface 20 to upper surface 9 (not shown) to provide a mounting location for wrist support 2. Other embodiments of the present invention envision other connections of wrist support 2. Generally, the invention envisions any connection that allows wrist support 2 to be connected from wrist support arm 3 along lower surface 17 such that wrist support 2 is above the plane of upper surface 9 (not shown). However, other embodiments include connections where wrist support 2 may not extend above the plane of upper surface 9 (not shown).

Distal end 19 of wrist support arm 3 provides a connection for mechanical stop 5. An embodiment of distal end 19 is an elongated extension of wrist support arm 3 in a generally T-shape conforming to the bounding circumference of the generally circular portion 22 of support platform 1.

Mechanical stop 5 may be connected to wrist support arm 3 by any manner common in the art. Various embodiments utilize brackets 16 connected from distal end 19 to mechanical stop 5. Other manners of attachment include adhesives, screws, bolts and a unitary portion of wrist support arm 3 extending as mechanical stop 5.

From this perspective, it may be seen that rotation of wrist support arm 3 may be accomplished by rotation of wrist support 2. Wrist support 2 will rotate to conform to a users comfort and movements of a pointer device such as a mouse. Rotation is limited to circular portion 22 of support platform 1 and will encounter resistance, or a stop, as either mechanical stop 5 or wrist support 2 is rotated from the circular portion 22 to the non-circular portion 8.

Now referring to FIG. 3, an illustration of the embodiment of FIG. 1 from a side perspective, connection of the various portions of an embodiment of the present invention may be more easily observed. A connection 21 connects mouse pad 4 to upper surface 9 of mouse platform 1. In various embodiments, mouse pad 4 rotates about brad 21. Other embodiments use connectors that extend from mouse pad 4 to brad 15 such that as mouse pad 4 is rotated, wrist support arm 3 rotates.

Various embodiments of te present invention include a small gap or space between wrist support arm 3 and lower surface 22, between proximal end 18 and side surface 20, and between mechanical stop 5 and side surface 20 to prevent any undesired friction or interference between the two such that wrist support arm 3 may freely rotate about the circular portion of support platform 1. However, other embodiments do not use a gap or space between wrist support arm 3 and lower surface 22.

While a single embodiment has been shown and described, it will be understood that the invention is not limited thereto, since many modifications may be made and will become apparent to those of ordinary skill in the art. For example, the present invention may be constructed of a unitary piece of material, the wrist support pad may be fixedly mounted to a rotating support platform, entirely circular constructions of the support platform or any other construction that is within the general guidelines of the resent invention.

What is claimed is:

1. An improved support assembly for providing ergonomic relief, comprising:
a substantially circular base plate having an upper surface, a lower surface and a sidewall surface, the upper surface designed to accommodate a computer pointer device;
a wrist support arm pivotally connected about the base plate, the wrist support arm having a proximal end and a distal end wherein the proximal end defines a support for a wrist of an operator and the distal end defines an upwardly extending sideplate opposite the wrist support, the wrist support arm capable of rotation through a plurality of positions; and,
a connection connecting the base plate to a computer workstation.

2. The support of claim 1 wherein the upper surface of the circular plate further comprises a surface for providing an increased coefficient of friction to allow the operator to actuate the pointer device.

3. The support of claim 1 wherein the wrist support pad is designed to position the wrist and arm of an operator in an ergonomic position whereby the frequency and severity of injuries is reduced.

4. The support of claim 1 wherein the substantially circular base plate further comprises a pointer support pad.

5. The support of claim 1 wherein the connection is a universal joint, the universal joint allowing for rotatable attachment to a computer workstation.

6. The support of claim 1 wherein the connection further comprises an arm, the arm connected to a computer workstation.

7. The support of claim 1 wherein the wrist support arm is rotatably connected at the center of the lower surface of the substantially circular base plate, the proximal end extending from along the lower surface to along the upper surface wherein the wrist support is removably attached and the distal end extending along an opposite radius of the lower surface of the substantially circular base plate wherein the sideplate extends from distal end along the sidewall and above a plane of the upper surface.

8. The support of claim 4 wherein the pointer support pad is rotatably connected to the upper surface.

9. The support pad of claim 4 wherein the pointer support pad is rotatably connected to the wrist support arm such that rotation of the wrist support arm rotates the support pad.

10. The support of claim 1 wherein the rotation of the wrist support arm is limited by a non-circular portion of the substantially circular base plate.

11. An improved, rotatable ergonomic support plate, the plate providing ergonomic comfort for operation of a pointer device, comprising:
a support plate, the support plate defined partially by a circle having an upper surface, a lower surface, and a side surface;
a wrist support element bar with a first end and a second end rotatably connected to the lower surface of the support plate, the wrist support element bar extending across a diameter of the lower surface defined by the circle;
a wrist support pad connected to the first end of the wrist support element bar and extending from the lower surface to a position at least partially over the upper surface;
a mechanical stop connected to the second end of the wrist support bar and extending along the side surface and above a plane of the upper surface, the mechanical stop providing a limit to movement of the pointer device on the upper surface and a limit to rotatable movement along the side surface.

12. The improved plate of claim 11 wherein the support plate further comprises a connection portion, the connection portion defined as a non-circular portion of the base plate.

13. The plate of claim 12 wherein the connection portion further comprises a swivel, the swivel capable of attachment to a computer workstation.

14. The plate of claim 12 wherein the portion extending from the support plate is a universal connector, the universal connector capable of rotatable connection to a base.

15. The plate of claim 14 wherein the universal connector is connected to an arm, the arm connected to the base.

16. The improved plate of claim 11 wherein the wrist support pad is capable of providing ergonomic comfort for an operator.

17. The improved plate of claim 11 wherein the mechanical stop removably attaches to the wrist support bar.

18. The improved plate of claim 11 wherein the support plate further comprises a pad.

19. The improved plate of claim 18 wherein the pad is rotatably connected to the support plate.

20. The improved plate of claim 19 wherein the pad is rotatably connected across the support plate to the wrist support element bar such that rotation of the wrist support element bar rotates the pad.

21. An improved support platform, the support platform designed to accommodate a pointer device, comprising:
a base plate, the base plate having an upper surface, a lower surface and a side surface;
a rotatable element rotatably connected to the base plate, the rotatable element having a distal end and a proximal end.

22. The support platform of claim 21 wherein the proximal end of the rotatable element further comprises a wrist support that extends from the proximal end to a position at least partially over the upper surface, the wrist support providing ergonomic comfort to an operator.

23. The support platform of claim 21 wherein the distal end of the rotatable element further comprises a second sidewall, the second sidewall extending from the end of the distal end, along the side surface and above the upper surface, the second sidewall providing a mechanical limit to movement of the pointer device.

24. The support platform of claim 21 wherein the base plate further comprises a hole, the hole for attachment to a computer work station.

25. The support platform of claim 21 wherein the base plate further comprises a pointer pad.

26. The support platform of claim 25 wherein the pointer pad is rotatably connected to the rotatable element.
